(19) United States
(12) Patent Application Publication
(10) Pub. No.: US 2016/0209789 A1
(43) Pub. Date: Jul. 21, 2016

(54) SHEET SEPARATION DEVICE, FIXING DEVICE, AND IMAGE FORMING APPARATUS

(71) Applicants: Kenji NOZAWA, Kanagawa (JP); Masami OKAMOTO, Kanagawa (JP); Yuuki KIKUSHIMA, Kanagawa (JP); Fumihiro HIROSE, Kanagawa (JP); Kensuke YAMAJI, Kanagawa (JP); Keisuke KUBOTA, Kanagawa (JP); Shuutaroh YUASA, Kanagawa (JP); Kaori HEMMI, Kanagawa (JP); Seiji SAITOH, Kanagawa (JP)

(72) Inventors: Kenji NOZAWA, Kanagawa (JP); Masami OKAMOTO, Kanagawa (JP); Yuuki KIKUSHIMA, Kanagawa (JP); Fumihiro HIROSE, Kanagawa (JP); Kensuke YAMAJI, Kanagawa (JP); Keisuke KUBOTA, Kanagawa (JP); Shuutaroh YUASA, Kanagawa (JP); Kaori HEMMI, Kanagawa (JP); Seiji SAITOH, Kanagawa (JP)

(73) Assignee: Ricoh Company, Ltd., Ohta-ku (JP)

(21) Appl. No.: 14/997,697

(22) Filed: Jan. 18, 2016

(30) Foreign Application Priority Data
Jan. 19, 2015 (JP) 2015-008047
Jul. 10, 2015 (JP) 2015-138641
Oct. 16, 2015 (JP) 2015-204957

(51) Int. Cl. G03G 15/20

(52) U.S. Cl. CPC G03G 15/2028

(57) ABSTRACT

A sheet separation device includes a separator disposed to contact one face of a sheet conveyed through a nip between conveyors contacting each other. The separator configured to separate from surfaces of the conveyors the sheet conveyed through the nip. The separator includes a conveyance face and a slanted face. The conveyance face is configured to contact and convey the sheet conveyed through the nip. The slanted face is disposed closer to the nip than the conveyance face and inclined with respect to the conveyance face toward one conveyor of the conveyors at a same side as the one face of the sheet.

### CROSS-REFERENCE TO RELATED APPLICATIONS

This patent application is based on and claims priority pursuant to 35 U.S.C. §119(a) to Japanese Patent Application No. 2015-008047, filed on Jan. 19, 2015, No. 2015-138641, filed on Jul. 10, 2015, and No. 2015-204957, filed on Oct. 16, 2015 in the Japan Patent Office, the entire disclosure of which is hereby incorporated by reference herein.

### BACKGROUND

1. Technical Field

Aspects of the present disclosure relate to a sheet separation device, a fixing device, and an image forming apparatus.

2. Related Art

A fixing device of an image forming apparatus may include a sheet separation device to separate from the surfaces of conveyance members a sheet passing through a nip formed by the conveyance members contacting each other. The fixing device includes rollers or belts as fixing members and the conveyance members. The rollers or the belts are selected according to a fixing system. For example, a fixing device of a heat roller fixing system heats and presses a sheet while passing the sheet through a nip formed with a heat roller and a pressure roller contacting each other. Alternatively, a fixing device of a belt fixing system employs a belt instead of the heat roller to decrease heat capacity than the heat roller.

The sheet separation device may have a separation claw in contact with the surface of a conveyance member, to separate the sheet from the surface of the conveyance member. Alternatively, a sheet separation device is proposed that includes a separation plate to scoop up an entire width area of a leading end of a sheet instead of the separation claw. The separation plate is disposed adjacent to a fixing member so as to maintain a non-contact relation between the separation plate and the fixing member.

### SUMMARY

In an aspect of the present disclosure, there is provided a sheet separation device that includes a separator disposed to contact one face of a sheet conveyed through a nip between conveyors contacting each other. The separator configured to separate from surfaces of the conveyors the sheet conveyed through the nip. The separator includes a conveyance face and a slanted face. The conveyance face is configured to contact and convey the sheet conveyed through the nip. The slanted face is disposed closer to the nip than the conveyance face and inclined with respect to the conveyance face toward one conveyor of the conveyors at a same side as the one face of the sheet.

In another aspect of the present disclosure, there is provided a fixing device that includes the sheet separation device.

In still another aspect of the present disclosure, there is provided an image forming apparatus that includes the fixing device.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a schematic view of an example of a configuration of a fixing device including a sheet separation device according to an embodiment of the present disclosure;

FIG. 2 is an enlarged view of a portion indicated by circle X1 in FIG. 1;

FIGS. 3A and 3B are diagrams of a first variation of the sheet separation device illustrated in FIG. 1;

FIG. 4 is a diagram of one failure in a comparative example of the sheet separation device;

FIG. 5 is a diagram of another failure in the comparative example of the sheet separation device;

FIG. 6 is a diagram illustrating a second variation of the sheet separation device illustrated in FIG. 1;

FIG. 7 is an enlarged view illustrating an example of a configuration of a convex processed portion disposed in a separator illustrated in FIG. 6;

FIG. 8 is an illustration of an example of a configuration in which the separator has a planar shape;

FIG. 9 is a diagram illustrating a third variation of the sheet separation device illustrated in FIG. 1;

FIG. 10 is an enlarged view of a portion indicated by circle X2 in FIG. 9;

FIGS. 11A and 11B are diagrams of examples of failures in a comparative example of the sheet separation device; and

FIG. 12 is a diagram of an example of an image forming apparatus including the fixing device illustrated in FIG. 1.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

The sheet separation device, which uses the separation plate, can guide the sheet to the separation plate by utilizing curvature-separation of the sheet that has been passed through a nip. In other words, the sheet passing through the nip takes an attitude of being separated from a belt by utilizing a shape restoring force according to a strength of own bending rigidity and being directed to the separation plate at the time of being rapidly changed in a movement direction due to curvature of a backing roller around which the belt is wound. To be specific, when a non-image portion positioned at a the leading end in the direction of movement of the sheet, that is, a part without an image which can adhere to the belt is separated from the belt, the sheet is guided in an ejection direction by the separation plate in the state of being captured by the separation plate disposed adjacent to the belt.

The sheet that has been passed through the nip bears an image including, for example, a fixed toner image and the like on one or both sides of front and rear in some cases. A face, on which the image is borne, of the sheet bearing the image is peeled off from the surface of the fixing member, and the sheet contacts the leading edge of the separation plate when reaching the leading edge of the separation plate, and is moved.

Meanwhile, the image immediately after passing through the nip is in a so-called semi-molten state, in which toner included in the image is not completely cooled and hardened. Thus, there is a risk that the image in the semi-molten state which is in contact with the leading edge of the separation plate is peeled off and disturbed when being rubbed by the leading edge of the separation plate at the time of passing through the leading edge of the separation plate. In particular, the leading edge of the separation plate is in line contact with the sheet over the entire span in a lateral direction of the sheet. Thus, an intensive contact pressure is likely to apply with respect to the sheet from the leading edge of the separation plate, and a contact resistance increases. The high contact pressure which causes the increase of the contact resistance becomes sliding pressure with respect to the image being borne on the sheet, and thus, there is a risk that the image is rubbed and damaged.

A thickness of a toner layer is various depending on the number of colors to form the image. For example, a gap between the toner and the separation plate decreases in the case of bearing a multi-color image which has a thicker toner layer than the case of using a single color. Accordingly, the image easily contacts the leading edge of the separation plate, and the damage on the image caused by the sliding pressure also easily becomes remarkable.

As described below, according to at least one embodiment of the present disclosure, a separator has a slanted face inclined so as not to contact an image on a recording medium, thus preventing a leading edge of the separator from damaging the image.

Referring now to the drawings, embodiments of the present disclosure are described below. In the drawings for explaining the following embodiments, the same reference codes are allocated to elements (members or components) having the same function or shape and redundant descriptions thereof are omitted below.

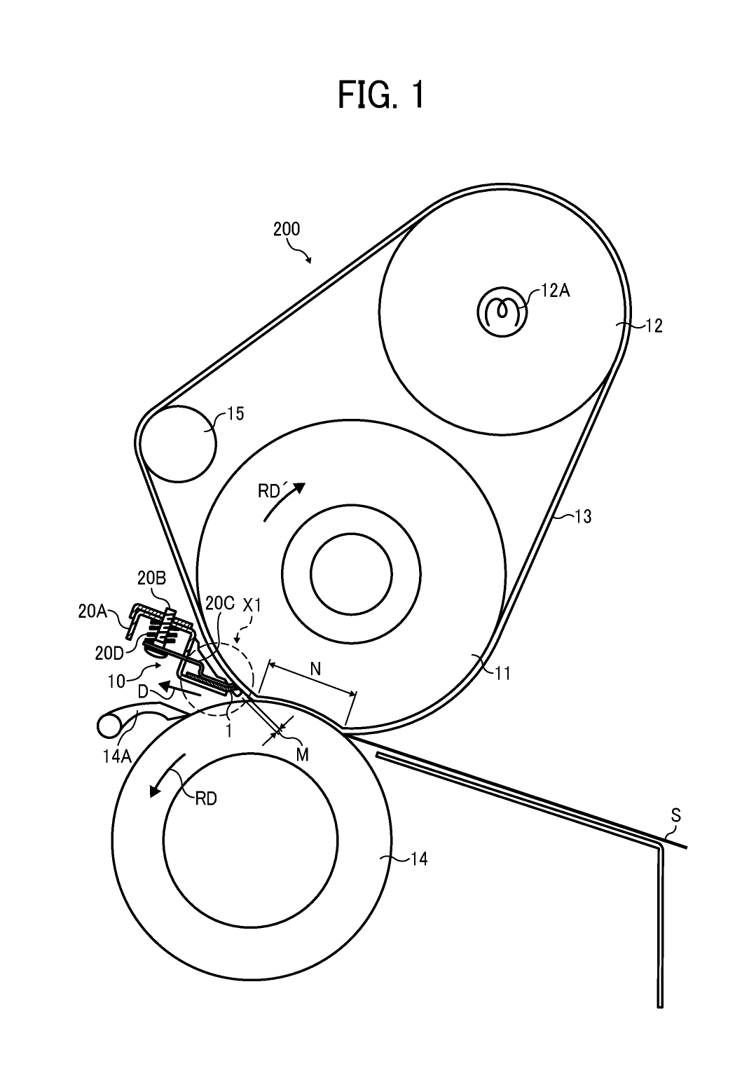

Hereinafter, embodiments of the present disclosure will be described with reference to the drawings. A fixing device 200 illustrated in FIG. 1 includes a sheet separation device 10 according to an embodiment of the present disclosure. The fixing device 200 employs a belt fixing system that includes a fixing roller 11, a heat roller 12, a fixing belt 13 stretched around the fixing roller 11 and the heat roller 12, and a pressure roller 14 which is in contact oppositely with the fixing roller 11. The fixing device 200 further includes a separation claw 14A and a tension roller 15. The separation claw 14A strips a sheet S as a recording medium if the sheet S is wound around the pressure roller 14. The tension roller 15 gives tension to the fixing belt 13. The sheet S to be used in the present embodiment is a sheet which bears an image including a toner image formed by toner, which is an image forming agent, on one face at the upper side of FIG. 1. The fixing belt 13 is heated by a heat source 12A equipped in the heat roller 12. The sheet S nipped and conveyed by a nip N to be formed by the fixing belt 13 and the pressure roller 14, which serve as a conveyor in contact with each other, is heated and pressed in the course of passing through the nip N with the one face thereof bearing the image in contact with the fixing belt 13, and the image is fixed.

The fixing roller 11 has a configuration in which a silicone rubber layer is provided on a surface of a metal core. The heat roller 12 is formed as a hollow roller made of aluminum or iron, and the heat source 12A, which uses, for example, a halogen heater or the like, is provided therein. The heat source 12A can use an induction heating (IH) mechanism instead of a resistive heat wire such as the halogen heater. The fixing belt 13 is an endless belt which uses a two-layer structure provided with a base material, for example, nickel, stainless, polyimide, or the like, and a silicone rubber layer laminated on the base material. As the fixing belt 13, a foamed silicone rubber layer that can suppress a temperature drop caused by radiation in order to shorten warm-up time can be used. The pressure roller 14 is a cylindrical roller in which a cored bar which is made of, for example, aluminum, iron, or the like and an elastic layer which provided on a surface of the cored bar, and is made of such as a silicone rubber. The pressure roller 14 is a member which is pressed and released from pressure under a certain pressure with respect to the fixing roller 11 by a pressing and the pressing-release mechanism. The pressure roller 14 and the fixing belt 13 correspond to the conveyors of the sheet S. When the pressure roller 14 is pressed by the fixing roller 11, the fixing belt 13 is pressed between both the rollers, and the nip N is formed.

A fixing operation of the image borne by the sheet S is performed when the nip N of the fixing belt 13 is formed. The fixing roller 11 and the pressure roller 14 are driven in the state of being in contact with each other, and rotate in directions of arrows RD and RD′ of FIG. 1 during the fixing operation of the image. The image including the toner image, which is borne on one surface of the sheet S is fixed as the toner is melted and permeated into the sheet S by heating and pressing at the time of passing through the nip N. Strictly speaking, however, the toner right after passing through the nip N is a semi-molten state and is a softened state like in the related art. The pressure roller 14 is separated from the fixing roller 11, and is released from the pressing when the fixing operation is not performed, for example, at the time of standby and the like. The heat source 12A of the heat roller 12 to be used during the fixing operation is retained at a predetermined temperature by a feedback control or the like depending on a temperature detection result obtained by a temperature sensor such as a thermistor.

The sheet S, which has been nipped and conveyed by the nip N during the fixing operation and ejected from the nip N in FIG. 1, is separated from the fixing belt 13, which also serves as the conveyor to contact the image borne by the sheet S, by the sheet separation device 10. The sheet separation device 10 includes a separator 1 to separate the sheet S, which has passed through the nip N, from the surface of the fixing belt 13 to contact one face of the sheet. In other words, the separator 1 is disposed at a position at which the sheet S can be separated from the surface of the fixing belt 13, which is placed opposite to the image borne on one face of the sheet S passing through the nip N formed between the fixing belt 13 and the pressure roller 14 as the conveyors contacting each other.

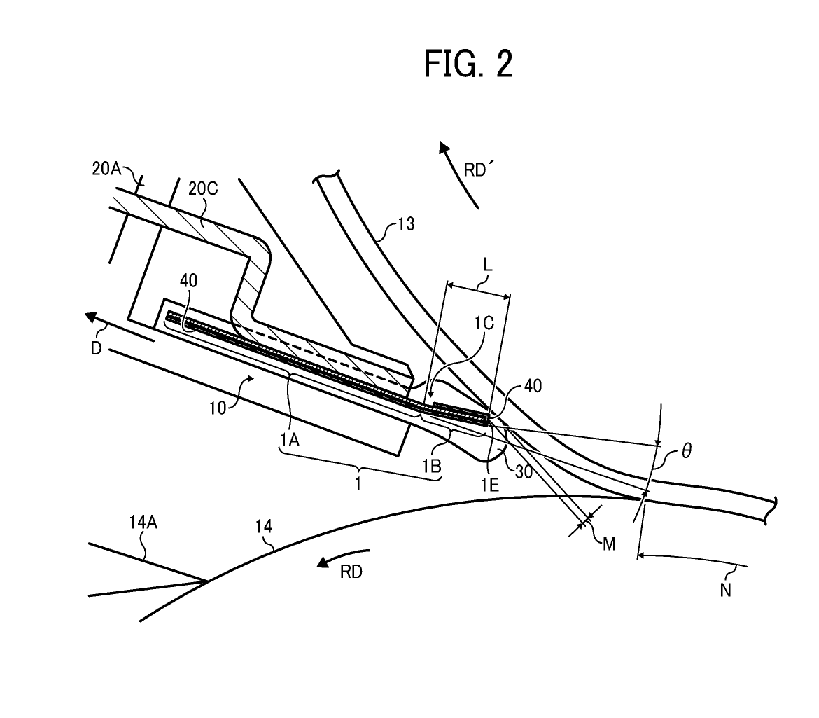

As illustrated in FIG. 2, the separator 1 is integrated with a support 20C. As illustrated in FIG. 1, the support 20C is supported with a stay 20A via an adjustment screw 20B. The stay 20A is attached to a housing 21 of the fixing device 200. A spring 20D holds the support 20C at a position at which an opposing gap between the separator 1 and the fixing belt 13 is adjusted with the adjustment screw 20B. The separator 1, which is made of a plate material such as a steel plate or a stainless steel, includes a conveyance face 1A and a slanted face 1B along a direction D of movement of the sheet S, which passes through the nip N and is ejected, as illustrated in FIG. 2. The conveyance face 1A is a face that can contact and convey the sheet S having passed through the nip N, and the slanted face 1B is a face which is disposed at a position closer to the nip N than the conveyance face 1A and inclined with respect to the conveyance face 1A.

The slanted face 1B is formed by bending the separator 1 and is inclined toward the fixing belt 13 as one conveyor disposed at the same side as one face of the sheet S bearing an image to be fixed. In other words, an edge on the nip N side of the slanted face 1B is away from an extension line of the conveyance face 1A of the sheet S toward the fixing belt 13 as illustrated in FIG. 2, and an edge 1E at a nip side end of the slanted face 1B is also away from a conveyance path of the sheet S.

In FIG. 2, a distance L from the edge 1E of the slanted face 1B to a boundary 1C between the conveyance face 1A and the slanted face 1B is set based on the following conditions. The boundary 1C is also an edge at a conveyance face side of the slanted face 1B. The distance is set such that a timing at which an image forming agent is cured to a degree not to be transferred to the conveyance face 1A by radiation of atmosphere at the time of arriving at the conveyance face 1A when the image forming agent such as toner included in the image is in the softened state at the time of passing through the nip N. In other words, a position of the boundary 1C between the conveyance face 1A and the slanted face 1B corresponds to a position through which the image borne by the sheet S in the state of being cured from the semi-molten state passes. The distance L is set to be in a range of from 1 mm to 3 mm in the present embodiment on consideration of the case in which a multi-color image with a layer thickness of the image forming agent being thickened is borne on one surface of the sheet S. The layer thickness of the image forming agent affects a tendency to contact the separator 1, and affects damage on the image caused by rubbing at the time of contact. However, the image borne by the sheet S, which has passed through the nip N, passed through the boundary 1C between the conveyance face 1A and the slanted face 1B and arrives at the conveyance face 1A, is cured from the semi-molten state, and thus, is not transferred even at the time of contacting with the conveyance face 1A.

The slanted face 1B has an inclination angle θ toward the fixing belt 13 with respect to the conveyance face 1A being set to be greater than 1 degree and less than 7 degrees, that is, 1°<θ<7°. A reason of the setting to θ<7° is as follows. A separation performance is determined depending on bending rigidity of the sheet S to which curvature separation is performed using a curvature of the fixing belt 13. When the curvature separation is not effectively performed on the sheet S with a smaller thickness and a low bending rigidity, for example, a part bearing the image, other than a leading end in the direction of movement at which a non-image portion is positioned, remains in the state of being pasted on the fixing belt 13. When the angle θ with respect to the sheet S moving in the state of being pasted on the fixing belt 13 is equal to or greater than 7°, the slanted face 1B is set to oppose the surface of the fixing belt 13 like a partition, which causes generation of failure that the sheet S is blocked by the slanted face 1B. When the sheet S is blocked, conveyance failure that the subsequent sheet S is prevented from being conveyed occurs. Further, there is a risk that the edge 1E of the slanted face 1B goes inside a plane of the conveyance path of the sheet S, and rubs the image borne by the sheet S when 1°<θ. Thus, an angle in a range of greater than 1° and less than 7° is selected to prevent the slanted face 1B from blocking the sheet S and allow the sheet S to be guided into the conveyance face 1A while eliminating the risk of rubbing the image.

The separator 1, in which the distance L from the edge on the nip N side of the slanted face 1B to the boundary 1C between the conveyance face 1A and the slanted face 1B, and the angle θ of inclination of the slanted face 1B are set as above, is provided in the state of being in non-contact with the fixing belt 13 which also serves as the conveyor and opposes the image. The separator 1 is in non-contact with the fixing belt 13 so as to prevent and/or suppress damage on the surface of the fixing belt 13. Thus, the separator 1 is disposed adjacent to the fixing belt 13 with the opposing gap, as indicated by reference code M in FIG. 2, at a degree that allows the non-image portion at the leading end of the sheet S floating up from the fixing belt 13 to be captured.

The opposing gap M of the separator 1 with respect to the fixing belt 13 is set and retained by a gap retainer 30. The gap retainer 30 is constantly in contact with a part opposing a non-sheet passage area on the fixing belt 13 at both sides in the lateral direction of the sheet, which is a direction perpendicular to the sheet face (FIG. 2) illustrating the separator 1, and positions the slanted face 1B of the separator 1 at a position spaced apart from the fixing belt 13 with the opposing gap M. The gap retainer 30, which is constantly in contact with the fixing belt 13, is made of a material in which a surface, such as aromatic polyether ether ketone of PEEK or PEK having a heat resistance and a wear resistance, is coated with fluorine resin. Incidentally, FIG. 2 seems that the separator 1 is buried inside the gap retainer 30, but the gap retainer 30 is only positioned at both sides in the lateral direction of the sheet of the separator 1 as described above. Accordingly, the edge on the nip N side of the slanted face 1B of the separator 1 is oppositely provided at a position spaced apart from the surface of the fixing belt 13 with the gap M to be independent from the gap retainer 30.

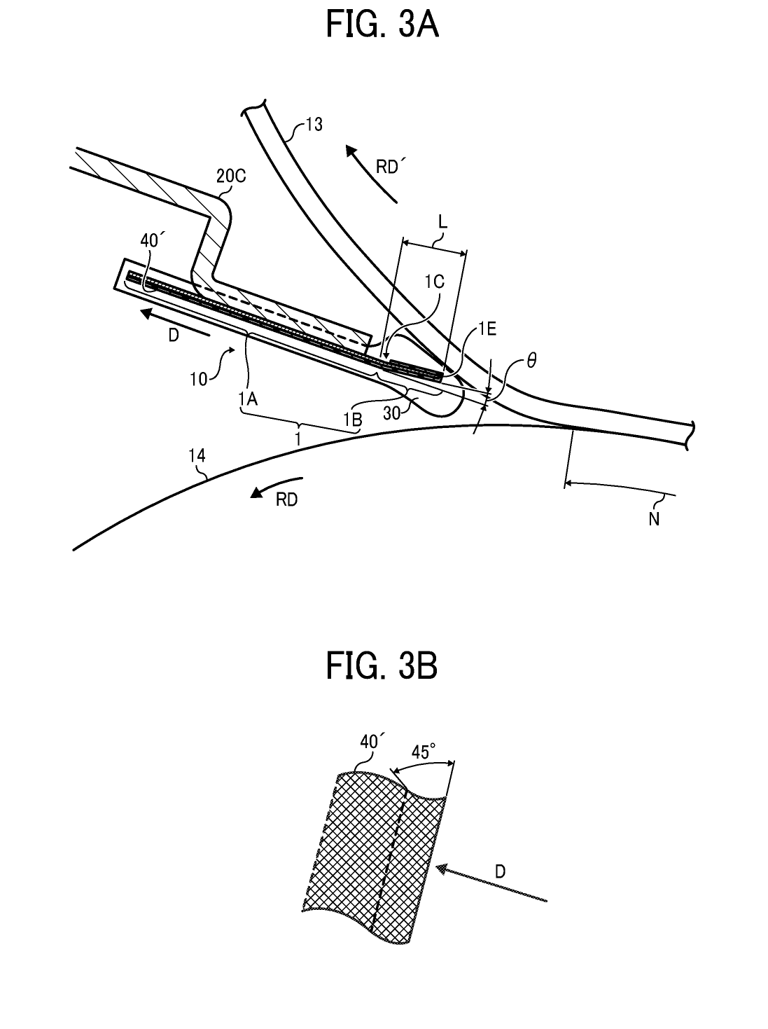

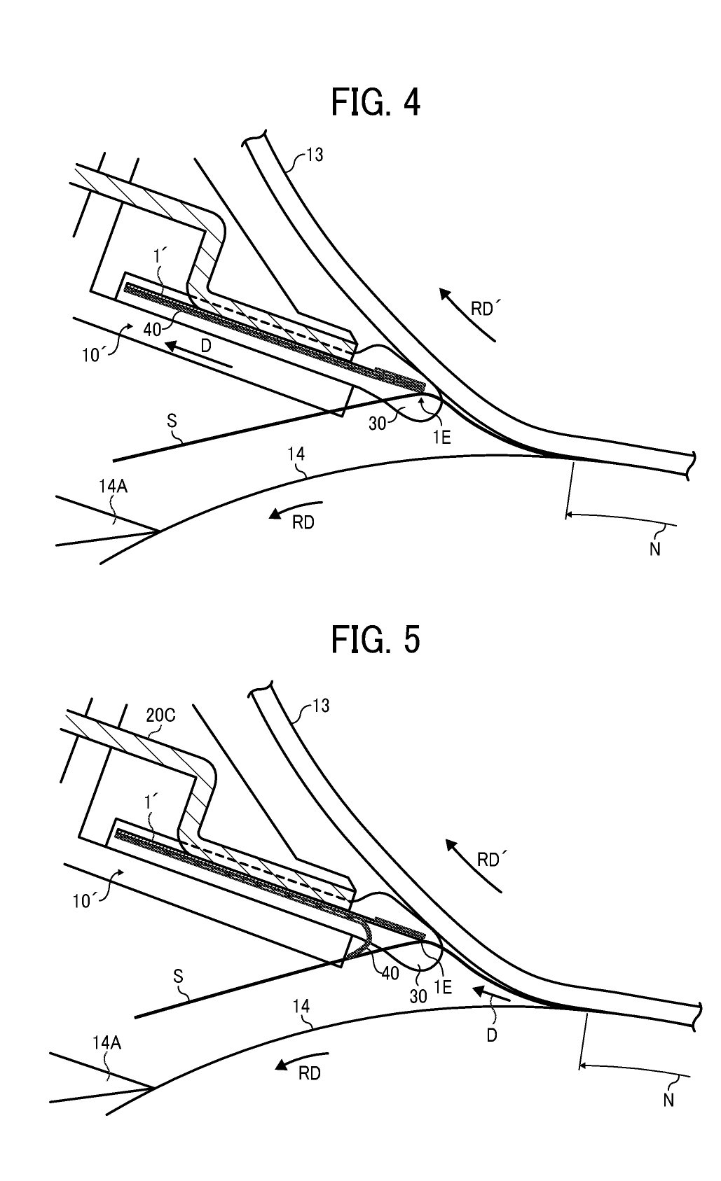

The edge 1E of the slanted face 1B opposing the nip N in the ejection direction of the sheet S is spaced apart from a movement path of the sheet S in the sheet separation device 10 provided with the above configuration. Since the edge 1E is not present within the conveyance path of the sheet S, the image bearing face of the sheet S does not contact the edge 1E as illustrated in FIGS. 3A and 3B, which is different from a case in which a hypothetical edge 1E is positioned within the conveyance face of the sheet S as illustrated in FIG. 4. Accordingly, it is possible to prevent the damage caused when the image is rubbed by the edge 1E. FIG. 4 illustrates a sheet separation device 10′, a separator 1′, and a coating layer 40. In particular, the sheet S moves from the slanted face 1B to the conveyance face 1A in the state in which the borne image is cured from the semi-molten state, and contacts the conveyance face 1A. Thus, the transfer of the image to the conveyance face 1A does not occur, and the own strength of the image is secured, which can result in few damage at the time of contact.

Next, a description will be given regarding a first variation as another example in relation to the embodiment of the present disclosure. In the present embodiment, the conveyance face 1A and the slanted face 1B of the separator 1 are formed using the coating layer 40 (illustrated in FIG. 2) with a low friction coefficient. The conveyance face 1A and the slanted face 1B of the separator 1 have at least a face opposing the image bearing face of the sheet S which is formed as a surface of the coating layer 40 using a tape made of a fluorine resin with a thickness of from 0.1 mm to 0.2 mm in FIG. 2.

The coating layer 40 is provided to mitigate influence of sliding pressure with respect to the image. However, when an intensively contact pressure is applied due to the line contact at the leading edge 1E, the coating layer 40 is easily sheared because the contact pressure becomes the sliding pressure. Accordingly, there is a risk of causing a defect such as breakage or peeling-off of the coating layer 40. Such breakage or peeling-off of the coating layer 40 affects also the thickness of the toner layer forming the image. For example, a gap between toner and the separator 1 decreases in a case in which the sheet S bears the multi-color image which has a thicker toner layer than the case of using a single color. Accordingly, there are many chances that the image and the leading edge of the separator 1 contact each other, thereby increasing a frequency to receive the sliding pressure. Accordingly, the breakage or the peeling-off caused by the shearing is likely to occur. When the breakage or the peeling-off of the coating layer 40 is likely to be caused, there is a risk that running cost required for exchange of the coating layer 40 increases.

However, it is possible to easily prevent the damage to the image by providing the coating layer 40 on the entire surface which contacts the image bearing face of the sheet S using the configuration provided with the conveyance face 1A and the slanted face 1B inclined with respect to the conveyance face 1A. Furthermore, the coating layer 40 does not receive the contact pressure intensively at the leading edge 1E of the separator 1. Incidentally, the thickness of the separator 1 is determined on consideration of durability including the wear resistance of the material and the like.

The coating layer 40 is not limited to the use of the tape simply made of the fluorine resin. FIGS. 3A and 3B are diagrams illustrating a variation of the coating layer (indicated by reference code 40′) of the sheet separation device. The coating layer 40′ illustrated in FIGS. 3A and 3B is made of polytetrafluoroethylene (PTFE) including glass cloth in which a glass fiber inclined at an angle of from 10° to 80° with respect to the direction D of movement of the sheet S in a plan view is disposed. FIGS. 3A and 3B illustrate cases in which the angle of the glass fiber is set to 45° at which a dispersion efficiency of a slide force is favorable.

It is possible to reduce a slide resistance caused between the image bearing face of the sheet S and the edge 1E in a case in which the conveyance face 1A and the slanted face 1B of the separator 1 is formed using the coating layer 40 or 40′ as above since the edge 1E positioned at a leading end of the slanted face 1B does not contact the sheet S. Accordingly, it is possible to reduce a shear load to the coating layer 40 or 40′, and it is possible to prevent and/or suppress generation of the breakage or the damage of the coating layer 40 or 40′. FIG. 5 illustrates a hypothetical, comparative example in which the coating layer 40 is sheared at the edge 1E, and the entire separator 1 is curled. However, the edge 1E does not contact the sheet S in the separator 1, the damage to the coating layer 40 or 40′ is mitigated, and the breakage or the damage of the coating layer 40 or 40′ is prevented or suppressed. Accordingly, it is possible to suppress an increase in cost required for the exchange. FIG. 5 illustrates the sheet separation device 10′ and the separator 1′, and the coating layer 40.

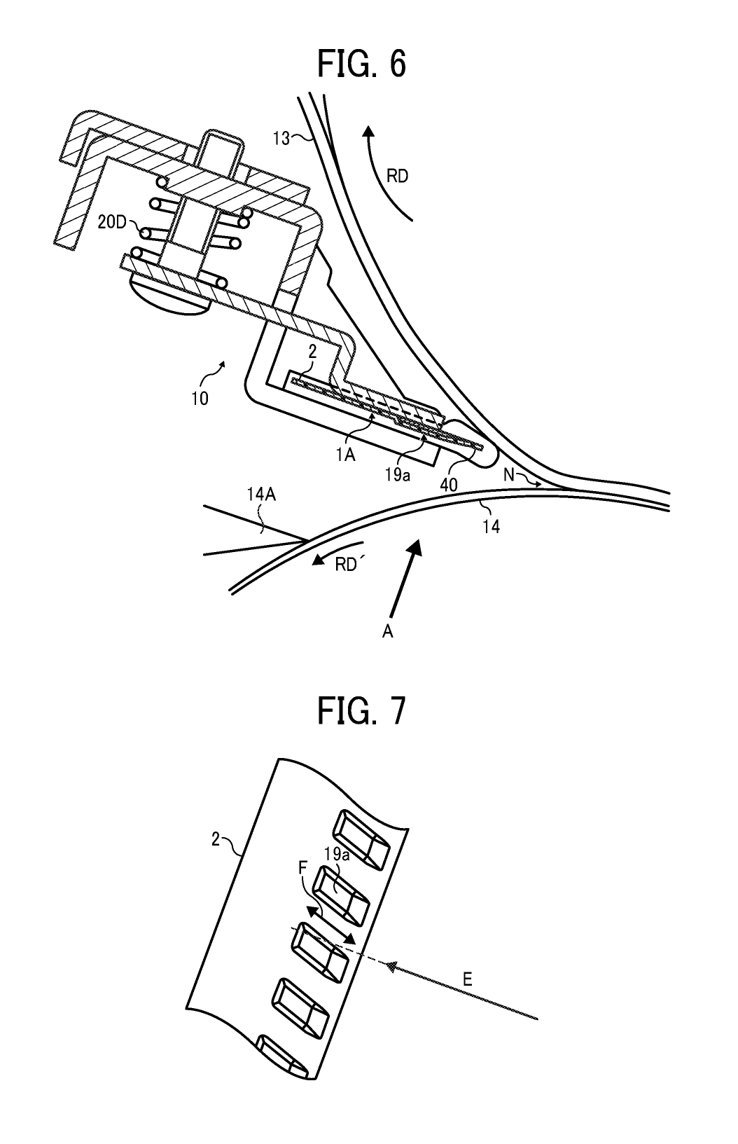

FIG. 6 illustrates a separator 2 as a second variation of the separator according to an embodiment of the present disclosure. Incidentally, the common members with those of the separators 1 and 1′, which have been already described, among members forming the separator 2 will not be described as appropriate. The separator 2 is formed on a pressure roller 14 side, which is a face at a sheet passage side of a sheet S adjacently to at a leading end of the separator 2, that is, a leading end at an upstream side in a rotation direction RD, and includes a plurality of convex processed portions 19a, which are protrusions protruding to a conveyance face 1A, in an axial direction of FIG. 6. A surface of the separator 2 is coated with a coating layer 40 so as to cover a fixing belt 13 side and a sheet passage face side. The convex processed portion 19a has a trapezoidal shape which is long in a direction F, and is disposed to be obliquely parallel to each other in a sheet passage direction E in the present variation as illustrated in FIG. 7. That is, the longitudinal direction F of the convex processed portion 19a is disposed to be inclined with respect to the sheet passage direction E as illustrated in FIG. 7. Incidentally, FIG. 7 is a diagram schematically illustrating a shape of the convex processed portion 19a seen from a direction indicated by arrow A of FIG. 6.

The coating layer 40 is a tape made of a fluorine resin having a thickness of from 0.1 mm to 0.2 mm, which has been already described above. The coating layer 40 may be Teflon (registered trademark) tape, or may be polytetrafluoroethylene (PTFE) including glass cloth in which a glass fiber is disposed. Further, it is desirable to provide the glass fiber to be inclined at an angle of from 10° to 80° with respect to a direction D of movement of the sheet S in a plan view in the case of using the PTFE including the glass cloth for the coating layer 40, similarly to the coating layer 40′ in the first variation that has been already described. In particular, it is more desirable to dispose the glass fiber to be inclined at 45° with respect to the direction D of movement of the sheet S in the plan view in order to improve dispersion efficiency of a frictional force.

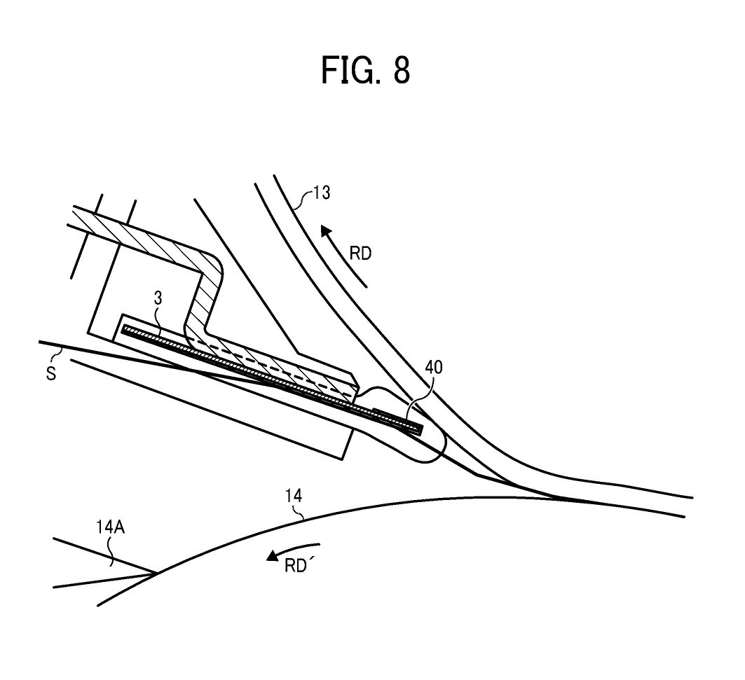

Meanwhile, a case is considered in which a separator 3 having a planar shape is used as illustrated in FIG. 8, for example. The sheet S is likely to be in surface contact with the entire separator 3 due to the planar shape. Thus, there is a concern that toner, on the sheet S with a high viscosity in a semi-molten state after passing through a nip N, contacts the separator 3 tinged with heat, and the sheet S is pasted on the separator 3 as illustrated in FIG. 8.

On the contrary, the separator 2 has the convex processed portion 19a so that a contact area between the sheet S and the separator 2 or the coating layer 40 formed on a surface of the separator 2 is reduced. Thus, the sheet S is hardly pasted on the separator 2, thereby suppressing or preventing damage of an image. In addition, the convex processed portion 19a is disposed to be parallel to each other obliquely with respect to movement direction the movement direction of the sheet S. Thus, the dispersion efficiency of the frictional force is improved, and further, the sheet S is easily separated, thereby suppressing or preventing the damage of the image.

The separator 2 has the configuration of only including the conveyance face 1A in FIG. 6, but may include the conveyance face 1A and a slanted face 1B similarly to the case illustrated in FIG. 2. In this case, it is preferable that the convex processed portion 19a be present astride the conveyance face 1A and the slanted face 1B. When the separator 2 includes the convex processed portion 19a also in the slanted face 1B, a contact area between the slanted face 1B and the sheet S is reduced, and a frictional resistance of the sheet S passing through the slanted face 1B is reduced. The deflection of the sheet S is reduced at the time of passing through the conveyance face 1A as the frictional resistance of the sheet S, applied to the slanted face 1B while the sheet S passes through the slanted face 1B, is reduced. Thus, the adhesion between the sheet S and the conveyance face 1A is suppressed, and the damage of the borne image is suppressed. The sheet S is likely to contact a boundary 1C which is a bent portion of the separator 2, but the convex processed portion 19a is astride the boundary 1C, and thus, the adhesion between the sheet S and the conveyance face 1A is further suppressed, and the damage of the borne image is suppressed.

The convex processed portion 19a may be provided, respectively, to the conveyance face 1A and the slanted face 1B. The adhesion of the sheet S to the separator 2 is more reliably suppressed by the convex processed portions 19a provided, respectively, to the conveyance face 1A and the slanted face 1B, and the damage of the borne image is prevented. The convex processed portion 19a may be provided only in the slanted face 1B.

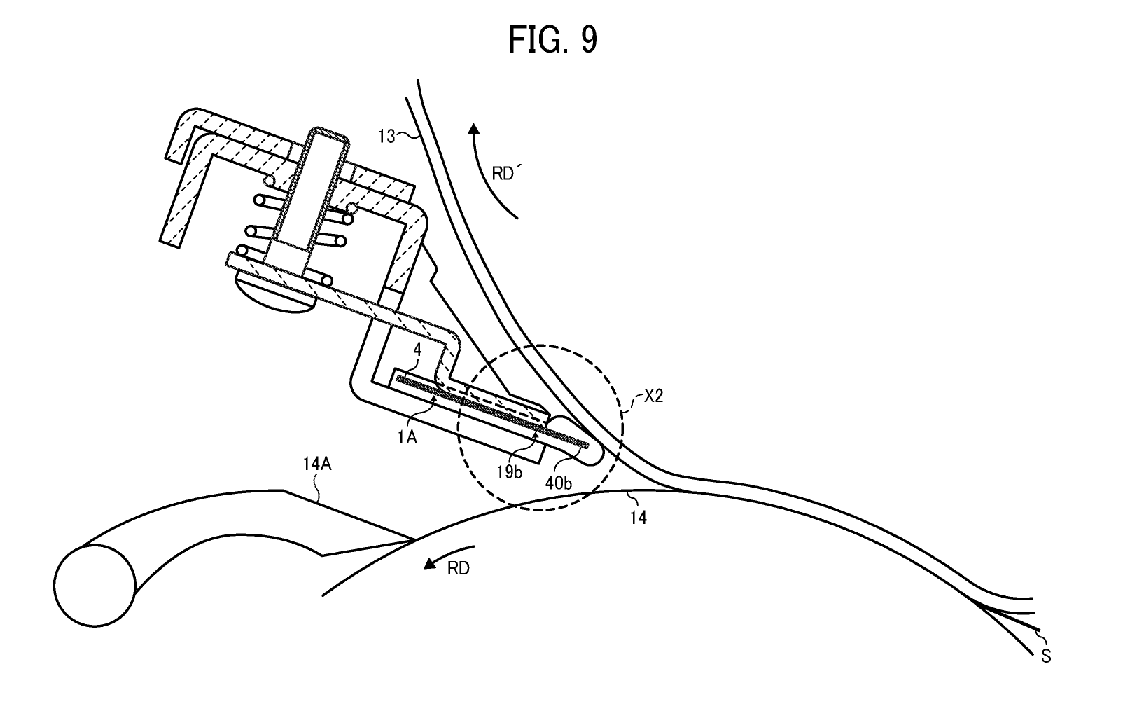

FIG. 9 illustrates a separator 4 as a third variation of the separator according to an embodiment of the present disclosure. Incidentally, the common members with those of the separators 1, 1′, 2, and 3, which have been already described, among members forming the separator 4 will not be described as appropriate. The separator 4 includes a blasted portion 19b which is formed by blasting on the entire surface of a conveyance face 1A which is on a pressure roller 14 side.

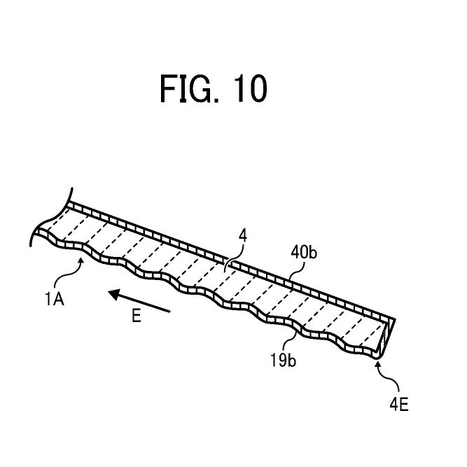

FIG. 10 is an enlarged view of the blasted portion 19b formed in the separator 4 illustrated inside a circle X in FIG. 9. The blasted portion 19b is formed by blasting a surface of a coating layer 40b which is formed by coating a surface of the separator 4, that is, a base material of the separator 4. The surface of the conveyance face 1A of the separator 4 in the blasted portion 19b has irregularities. To be specific, the blasted portion 19b is formed such that a cross-sectional shape of the conveyance face 1A of the separator 4, along a sheet passage direction (arrow E in FIG. 10) of a sheet S from an edge 4E of the separator 4, has a waveform. The blasted portion 19b is set to have a surface roughness within a range of Ra 0.6 to Ra 10 uniformly with respect to the entire surface of the conveyance face 1A.

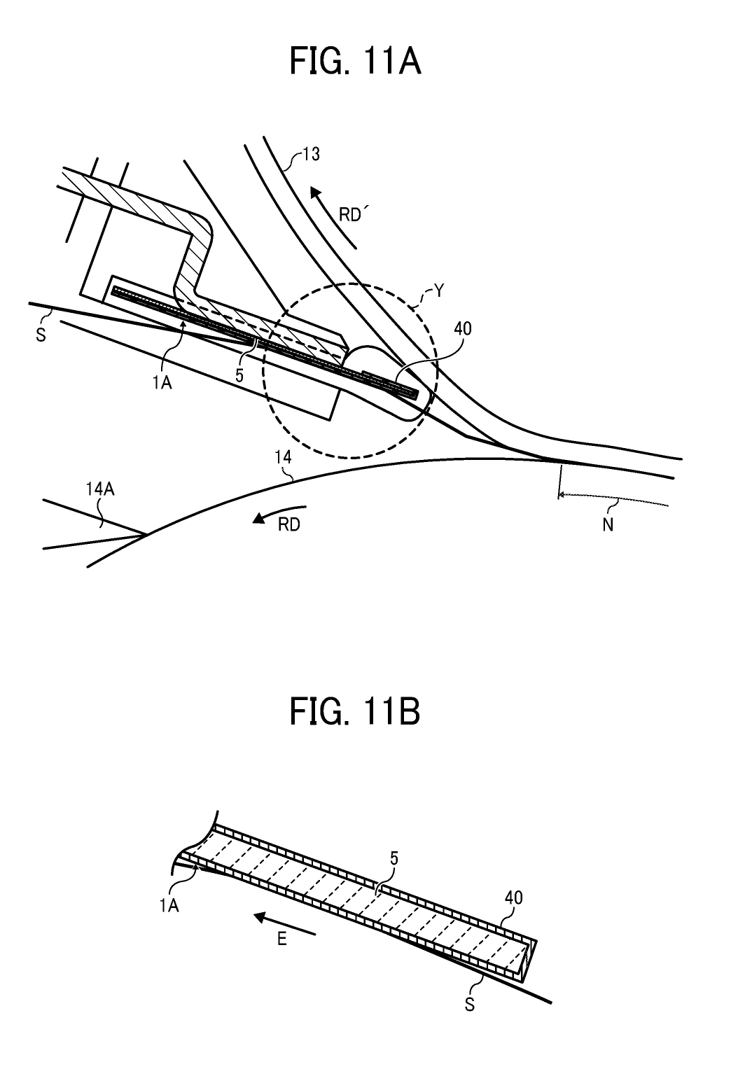

A case is considered in which a conveyance face 1A of a separator 5 is smooth as illustrated in FIGS. 11A and 11B. Incidentally, FIG. 11B is an enlarged view of a state in which the separator 5 and the sheet S are in contact with each other in a circle Y of FIG. 11A. Since the conveyance face 1A of the separator 5 is smooth, the sheet S has a large contact area with respect to the conveyance face 1A of the separator 5. Thus, there is a concern that toner, on the sheet S with a high viscosity after passing through a nip N, contacts the separator 5 tinged with heat, and the sheet S is pasted on the separator 5.

However, the separator 4 illustrated in FIG. 9 and FIG. 10 includes the blasted portion 19b, and thus, the contact area of the sheet S between the conveyance face 1A is reduced, the sheet S is hardly pasted on the separator 4, and the damage of the borne image is suppressed.

The blasted portion 19b is uniformly provided with respect to the entire surface of the conveyance face 1A, but may be set such that a surface roughness thereof becomes finer as approaching the edge 4E at an upstream side in a direction E, and the surface roughness becomes rougher at a downstream side in the direction E than that of the upstream side. Since a lot of toner still in a semi-molten state on the sheet S is present at the edge 4E, there is a risk that an image borne on the sheet S is peeled off, and is disturbed at the time of being rubbed by the blasted portion 19b with the rough surface roughness when the sheet S passes through the upstream side in the direction E. However, it is possible to suppress the damage of the borne image by setting the surface roughness at the edge 4E to be finer.

The coating layer 40b is formed by coating the base material of the separator 4 with fluorine resin, which is a fluorine-based material, to have a film thickness to be set within a range of 10 μm to 50 μm. The coating layer 40b may be formed by pasting a tape made of a fluorine resin on the base material of the separator 4 similarly to the coating layer 40, instead of the coating of the fluorine-based material. In the case of forming the coating layer 40b using the tape, the blasting may be performed prior to or after pasting the tape on the base material of the separator 4.

The separator 4 illustrated in FIG. 9 has the configuration including only the conveyance face 1A similarly to the separator 2 described above, but may include the conveyance face 1A and a slanted face 1B similarly to the case illustrated in FIG. 2. In this case, it is desirable that the blasted portion 19b be provided not only to the conveyance face 1A, but also to the slanted face 1B. When the separator 4 includes the blasted portion 19b also in the slanted face 1B, a contact area between the slanted face 1B and the sheet S is reduced, and a frictional resistance against the sheet S passing through the slanted face 1B is reduced. When the frictional resistance of the sheet S toward the slanted face 1B at the time of passing through the slanted face 1B is reduced, the deflection of the sheet S at the time of passing through the conveyance face 1A can be reduced. Thus, the adhesion between the sheet S and the conveyance face 1A is suppressed, and the damage of the borne image is suppressed.

When the blasted portion 19b is provided at least in the conveyance face 1A, the contact area between the sheet S and the conveyance face 1A is reduced, the adhesion at the conveyance face 1A is suppressed, and the damage of the borne image is suppressed. However, it is preferable that the blasted portion 19b be present at a position astride at least the conveyance face 1A and the slanted face 1B. The sheet S is likely to contact the boundary 1C which is a bent portion of the separator 2, thus the adhesion with the conveyance face 1A is suppressed by the blasted portion 19b, and the damage of the borne image is prevented. It is desirable that the blasted portion 19b may be set such that the surface roughness thereof becomes finer as approaching the edge 4E at the upstream side in the direction E, and the surface roughness becomes rougher at the downstream side in the direction E than that of the upstream side also in the case in which the separator 4 includes the slanted face 1B.

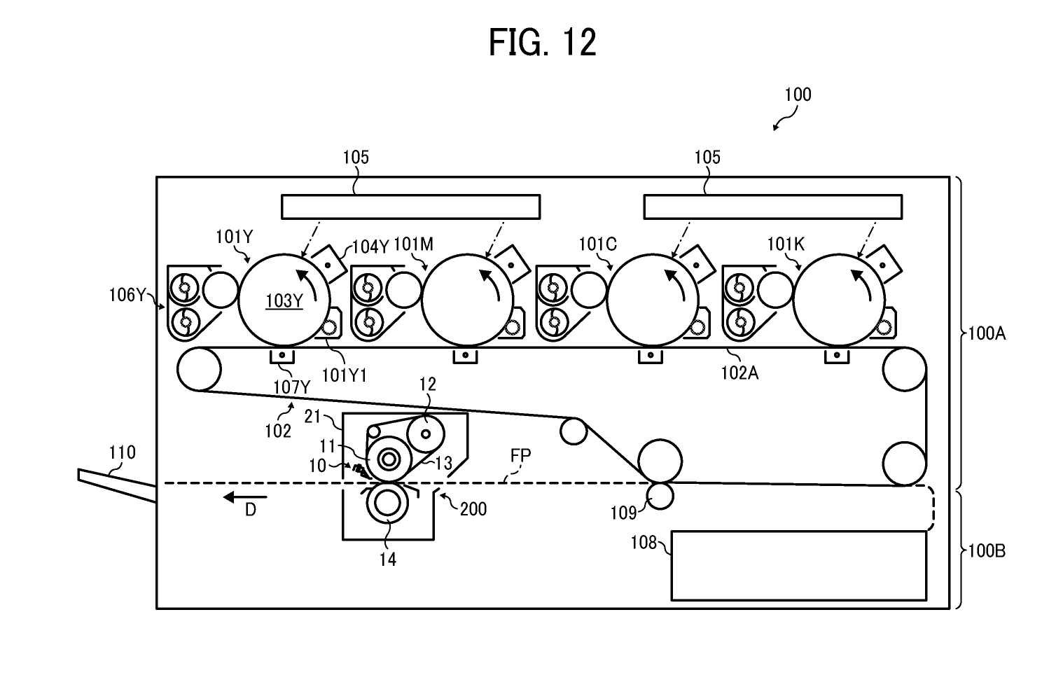

FIG. 12 is a diagram of an example of an image forming apparatus 100 according to an embodiment of the present disclosure, including the fixing device 200 illustrated in FIG. 1. In FIG. 1, the image forming apparatus 100 is illustrated as a color printer. However, the image forming apparatus is not limited to the color printer.

The image forming apparatus 100 includes an image forming section 100A and a sheet feed section 100B. The image forming section 100A is positioned at an upper side and the sheet feed section 100B is positioned at a lower side in FIG. 12 relative to a feed path FP of the sheet S passing through the fixing device 200. A plurality of image forming units 101Y, 101M, 101C and 101K are disposed in the image forming section 100A along one of stretched surfaces of an intermediate transfer belt 102A provided in an intermediate transfer device 102. The image forming units 101Y, 101M, 101C and 101K are used as stations to form respective color images of yellow, magenta, cyan, and black which are toners having a complementary color relation with color-separated colors. The image forming apparatus 100 illustrated in FIG. 12 employs a tandem system in which the respective image forming units 101Y, 101M, 101C and 101K are disposed side by side along one of the stretched surfaces of the intermediate transfer belt 102A.

All the image forming units 101Y, 101M, 101C and 101K have the same configuration. A description will be given regarding a configuration and operation of the image forming unit 101Y of a yellow image as follows. The image forming unit 101Y is provided with a photoconductor drum 103Y which is a latent image bearer rotatable in an arrow direction in FIG. 12. The photoconductor drum 103Y forms an image including a toner image according to an electrophotographic image forming process using a charging device 104Y, a writing device 105, and a developing device 106Y disposed adjacent to the photoconductor drum 103Y. The toner image is transferred to the intermediate transfer belt 102A provided in the intermediate transfer device 102 by a primary transfer device 107Y. Incidentally, reference numeral 101Y1 represents a cleaning device in FIG. 12. The toner image is formed as a multi-color image other than a single-color image when being formed in the image forming units 101M, 101C, and 101K in addition to using the yellow, the image forming units 101Y, 101M, 101C and 101K on which images are formed, are selected, and the images are sequentially transferred to the intermediate transfer belt 102A. An image in which the images of the respective colors from the image forming units 101Y to 101K are transferred and superimposed one on another is collectively transferred to the sheet S to be fed out from a sheet feed tray 108 equipped in the sheet feed section 100B by a secondary transfer device 109.

The sheet S to which the image has been collectively transferred, passes through the secondary transfer device 109, and then, the image is fixed by the fixing device 200 disposed in the feed path FP of the sheet S. The fixing device 200 has the configuration illustrated in FIG. 1, and fixes the image borne on the sheet S by heating and pressing. The sheet S, which has passed through the fixing process in fixing device 200, is separated from the fixing belt 13 which is the conveyor forming the nip N by the sheet separation device 10 illustrated in FIG. 1, and is guided toward an ejection tray 110.

As above, the preferred embodiments of the present disclosure have been described, but the present disclosure is not limited by the corresponding specific embodiments. Various modifications and changes can be made within a range of a gist of the present disclosure described in the claims otherwise particularly limited in the above description. For example, the present disclosure can be applied targeting not to the belt fixing system, but to a roller to be used in a heat roller fixing system as the conveyor. In other words, it is possible to provide the configuration capable of forming a nip in which fixing can be performed in the course of conveying a sheet. Further, the target of the present disclosure is not limited to the fixing device, but the present disclosure can be applied also to a sheet conveyance device in which a sheet bearing an image needs to be separated. In addition, it is also possible to cause the conveyance face 1A to be inclined in the clockwise direction about the position of the boundary 1C between the conveyance face 1A and the slanted face 1B illustrated in FIG. 2 as the configuration of the conveyance face 1A. Accordingly, it is possible to more effectively suppress the damage of the image by reducing a change that the image of the sheet S moving in the direction indicated by arrow D contacts the conveyance face 1A. Further, the plurality of convex processed portions with the trapezoidal shape are provided in the second variation, but one convex processed portion may be provided. Further, the shape thereof is not particularly limited, and may be a cylindrical shape or a hemispherical shape as long as being a convex shape toward the sheet passage face.

The convex processed portion 19a illustrated in the above-described second variation may be combined with the third variation. That is, the separator 4 may coat the surface of the conveyance face 1A on which the convex processed portion 19a is formed with the fluorine-based material and performs the blasting. When the separator 4 has the convex processed portion 19a, the sheet S is suppressed from contacting the conveyance face 1A more reliably, and the damage of the borne image is suppressed. It is possible to obtain an advantage that the irregularities become smoother, and the surface roughness is easily secured when the blasted portion 19b is blasted after the coating. Besides, the blasted portion 19b may be formed by performing the coating after blasting the base material of the conveyance face 1A to allow the irregularities of the base material to appear on the surface of the coating layer 40b regardless of presence or absence of the convex processed portion 19a.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A sheet separation device comprising a separator disposed to contact one face of a sheet conveyed through a nip between conveyors contacting each other, the separator configured to separate from surfaces of the conveyors the sheet conveyed through the nip,
the separator including:
a conveyance face configured to contact and convey the sheet conveyed through the nip; and
a slanted face disposed closer to the nip than the conveyance face and inclined with respect to the conveyance face toward one conveyor of the conveyors at a same side as the one face of the sheet.

2. The sheet separation device according to claim 1,
wherein the slanted face is a slanted face formed by bending the separator.

3. The sheet separation device according to claim 1,
wherein the sheet bears an image comprising an image forming agent on the one face, and
wherein a distance from the nip to a boundary between the conveyance face and the slanted face is set to a distance with which the image forming agent, which passes through the nip in a softened state, is curable to a degree not to be transferred to the conveyance face even when contacting the conveyance face.

4. The sheet separation device according to claim 1,
wherein a length from a conveyance face side edge of the slanted face to a nip side edge of the slanted face is in a range of from 1 mm to 3 mm.

5. The sheet separation device according to claim 1,
wherein an angle of inclination of the slanted face with respect to the conveyance face is in a range of greater than 1 degree and less than 7 degrees.

6. The sheet separation device according to claim 1,
wherein the conveyance face and the slanted face are made of a coating layer with a low friction coefficient that constitutes a surface of the separator.

7. The sheet separation device according to claim 6,
wherein the coating layer includes a fluorine resin having a thickness of from 0.1 mm to 0.2 mm.

8. The sheet separation device according to claim 6,
wherein the coating layer comprises polytetrafluoroethylene (PTFE) including a glass cloth in which glass fibers are inclined at an angle of from 10 degrees to 80 degrees with respect to a direction of movement of the sheet.

9. A fixing device comprising the sheet separation device according to claim 1.

10. An image forming apparatus comprising the fixing device according to claim 9.
